(19) United States
(12) Patent Application Publication
(10) Pub. No.: US 2004/0209669 A1
(43) Pub. Date: Oct. 21, 2004

(54) Gaming machine

(76) Inventors: Kazuki Emori, Tokyo (JP); Hideaki Imura, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/697,039

(22) Filed: Oct. 31, 2003

(30) Foreign Application Priority Data
Nov. 18, 2002 (JP) 2002-334123

(51) Int. Cl. A63F 13/00

(52) U.S. Cl. 463/20

(57) ABSTRACT

A pinball slot machine 1 includes: speaker main units 2108 each having a part exposed to the front of a cabinet of the pinball slot machine 1 for outputting sound toward the front; LED boards 2106 and LEDs 2106a to 2106d being placed away from the exposed parts of the speaker main units 2108 and attached to the cabinet of the pinball slot machine 1 for emitting light; and speaker covers 210 being provided so as to surround the exposed parts of the speaker main units 2108 and cover the LED boards 2106 and the LEDs 2106a to 2106d. The LEDs 2106a to 2106d are oriented so as to be substantially parallel with the front of the cabinet of the pinball slot machine.

### BACKGROUND OF THE INVENTION

1. Field of the Invention

The present invention relates to a gaming machine including a speaker cover for emitting light.

2. Description of the Related Art

A recent slot machine including stop buttons (a so-called “pinball slot machine” or a so-called “Pachi-Slot machine” in Japan) has a mechanical variable display means provided with a plurality of rotatable reels for variably displaying various symbols in a front display window or an electrical variable display means for displaying symbols on reels on a screen. As the player performs start operation, control means controls the variable display means to rotate the reels, thereby variably displaying symbols. Then, the rotating reels are sequentially stopped in order automatically in a given time or as the player performs stop operation. At this time, if the symbols on the reels appearing in the display window become a specific combination (winning symbol combination), game medium such as medals or coins are paid out to the player as the prize of the winning game.

In a model in a related art, a cabinet of a gaming machine has a door that can be opened and closed, and a display panel section is provided in front of the door. The display panel section is provided on the upper left and right with a display with a light source that emits a point light covered with a lens cover. In the gaming machine in the related art, a stepped shape for diffusing and reflecting light from the light source is formed in the surroundings of the light source of the display, and the light diffused by means of the stepped shape is applied to the inside of the front of the lens cover. According to the above-described structure, it is possible to give the player an impression that the full face of the lens cover emits light uniformly.

The above-described structure is disclosed in JP-A-11-156001 (see FIG. 1).

### SUMMARY OF THE INVENTION

However, in the gaming machine in the related art, a plurality of light sources face the lens cover. Therefore, there occurs a problem that it is difficult to apply the gaming machine intact to a configuration wherein a speaker is disposed in the display described above and a speaker cover section is caused to emit light so that the acoustic and illumination effects can be provided at the same position. That is, the light source is disposed surrounding the speaker and thus if the stepped shape is formed in the surroundings of the light source, diffusion of light from the light source is insufficient and it is difficult to cause the full face of the cover to emit light uniformly.

It is an object of the invention to provide a gaming machine for giving a player the impression as if the full face of a speaker cover emitted light by means of a light source attached to a speaker section.

According to the invention, there is provided a gaming machine including: internal lottery means (for example, main control circuit 71) configured to hold an internal lottery of a game using a random number at a predetermined timing; sound output means (for example, speaker 21L, 21R) having a part exposed to a front surface of a cabinet of the gaming machine and configured to output sound toward a front direction; light emission means (for example, LED board 2106) disposed away from the exposed part of the sound output means and attached to the cabinet, the light emission means configured to emit light; and a cover (for example, speaker cover 210) being provided to surround the exposed part of the sound output means and to cover the light emission means, wherein a light source (for example, LED 2106a to 2106d) of the light emission means is oriented to be substantially in parallel with the front surface of the cabinet of the gaming machine.

According to the configuration, the light source of the light emission means is placed in a sideways position relative to the front of the gaming machine, so that the player is not given the impression that the light source is a light source of point light emission, and the player feels that the full face of the cover emits light. Therefore, the high illumination effect can be provided.

In the gaming machine of the invention, a recess (for example, recess 2110) having a stepped part may be formed on the front surface of the cabinet, the sound output means may include a part exposed to a bottom of the recess, and the light emission means may be attached to the stepped part (for example, stepped part 2110d) of the recess.

According to the configuration, the light source of the light emission means is placed in a sideways position relative to the front of the gaming machine and further is disposed in the stepped part of the recess in the cabinet of the gaming machine. Thus, the player is more easily given that the full face of the cover emits light as compared with the case where the light emission means is attached to the cover. Therefore, the higher illumination effect can be provided.

In the gaming machine of the invention, continuous asperities (for example, asperities 2107) may be formed on an inner surface of the cover.

According to the configuration, the asperity shape irregularly reflects and diffuses light emitted by the light emission means, so that the player is given the impression that the full face of the cover emits light. Therefore, the high illumination effect can be provided.

In the gaming machine of the invention, the light emission means may include a light emitting diode (for example, four LEDs 2106a to 2106d).

According to the configuration, light emitting diodes (LEDs) are used as the light emission means. Thus, the light source is adequately small, for example, as compared with the case where a lamp is used, so that the player is hard to feel that the light emission is point light emission, and the energy saving effect can also be expected.

### BRIEF DESCRIPTION OF THE DRAWINGS

In the accompanying drawings:

FIG. 1 is a drawing to show a first embodiment of a gaming machine according to the invention and is a perspective view to show the appearance of a pinball slot machine as gaming machine;

FIG. 2 is a perspective view to show the appearance of the pinball slot machine with reels displayed in the first embodiment of the invention;

FIG. 3 is a perspective view to show the outline of a speaker in the first embodiment of the invention;

FIG. 4 is a perspective view to show the back (inside) of a speaker cover in the first embodiment of the invention;

FIG. 5 is a drawing to show the cabinet portion of the speaker in the first embodiment of the invention;

FIG. 6 is a drawing to describe diffusion of LED light in the first embodiment of the invention;

FIG. 7 is a drawing to show the configuration of a liquid crystal display in the first embodiment of the invention;

FIG. 8 is a drawing to show symbol rows drawn on the outer peripheral surfaces of the reels in the first embodiment of the invention;

FIG. 9 is a drawing to show prizes and numbers of paid-out medals corresponding to winning symbol combinations in the first embodiment of the invention;

FIG. 10 is a block diagram to show the configuration of a main control circuit in the first embodiment of the invention;

FIG. 11 is a drawing to show a winning stop control table used when internal winning of small prize is accepted in the first embodiment of the invention;

FIG. 12 is a drawing to show a forward push, center push losing stop control table used when internal winning of small prize is accepted in the first embodiment of the invention;

FIG. 13 is a drawing to show a reverse push losing stop control table used when internal winning of small prize is accepted in the first embodiment of the invention;

FIG. 14 is a block diagram to show the configuration of a sub-control circuit in the first embodiment of the invention;

FIG. 15 is a perspective view to show the back (inside) of a speaker cover in a second embodiment of the invention; and

FIG. 16 is a drawing to show the cabinet portion of a speaker in a third embodiment of the invention.

### DETAILED DESCRIPTION OF THE PREFERRED EMBODIMENTS

Referring now to the accompanying drawings, there are shown preferred embodiments of the invention.

### First Embodiment

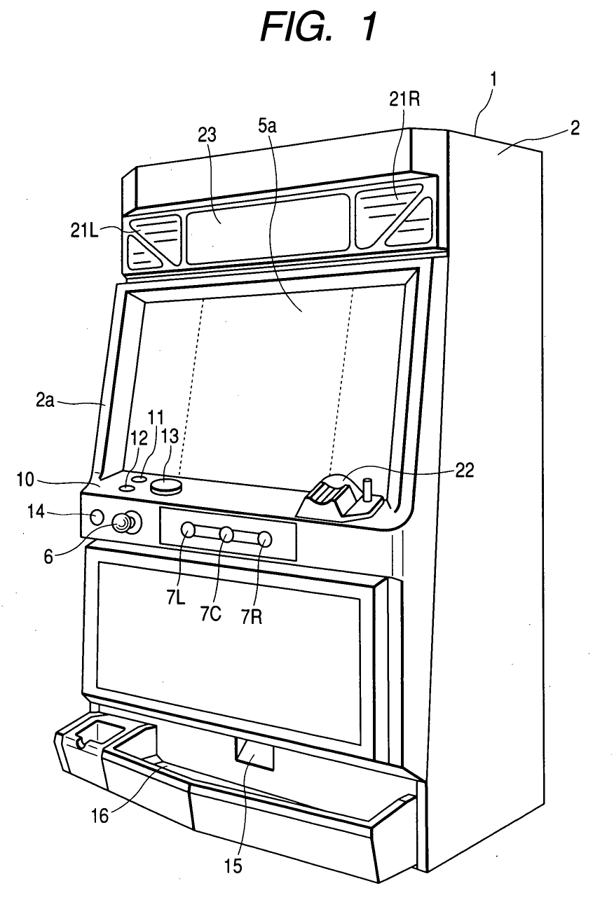

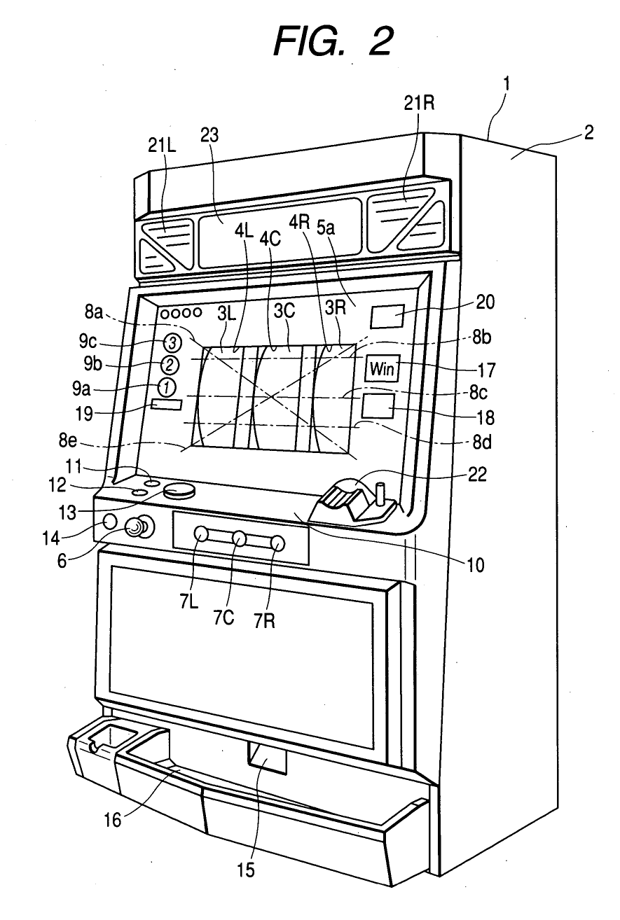

FIG. 1 shows a first embodiment applying a gaming machine according to the invention to a pinball slot machine (a so-called “Pachi-Slot machine” in Japan). Here, BET lamps 9a, 9b, and 9c, a WIN lamp 17, a payout display unit 18, a credit display unit 19, and a bonus game information display unit 20 are not shown. FIG. 2 shows a state that a full screen display is not displayed by a liquid crystal display in a display screen 5a, and reels 3 placed at the back of the liquid crystal are displayed through the display screen 5a (liquid crystal display).

Hereinafter, the configuration will be discussed. In FIGS. 1 and 2, a pinball slot machine 1 as a gaming machine is provided for the player to play a game using game medium such as a card storing information of the game play value given to the player as well as coins, medals and tokens. In the following description, it is assumed that the player uses medals.

A panel display unit 2a roughly as a vertical plane is formed at the front of a cabinet 2 forming the whole portion of the pinball slot machine 1, and speakers 21L and 21R are provided on the upper left and right of the cabinet 2. A payout table panel 23 for displaying winning symbol combination, the number of paid-out medals, and the like is provided between the two speakers 21L and 21R.

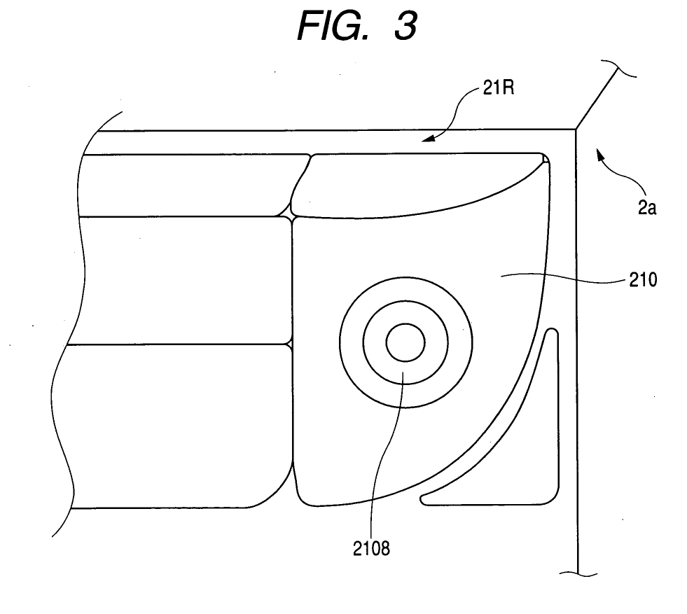

The configuration of the speaker 21R is as shown in FIGS. 3 through 6. The configuration of the speaker 21L is also similar to that of the speaker 21R and therefore the configuration of the speaker 21L is not shown and will not be discussed.

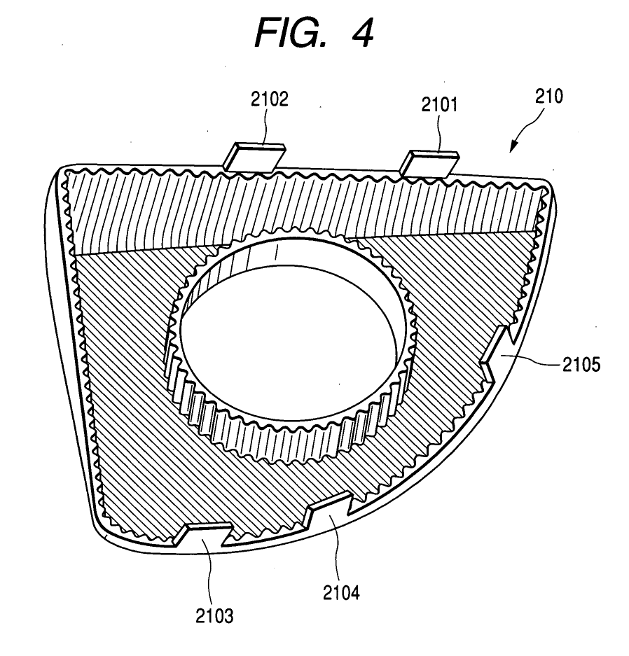

The speaker 21R has a speaker main unit 2108 (contained in speaker 21L, 21R) embedded in a cabinet and a transparent or semitransparent resin speaker cover 210 for covering the speaker main unit 2108 (shown in FIG. 3). The speaker cover 210 is formed in an outer margin with attachment projections 2101 to 2105 and is formed on an inner surface with asperities 2107 for diffusing light (shown in FIG. 4).

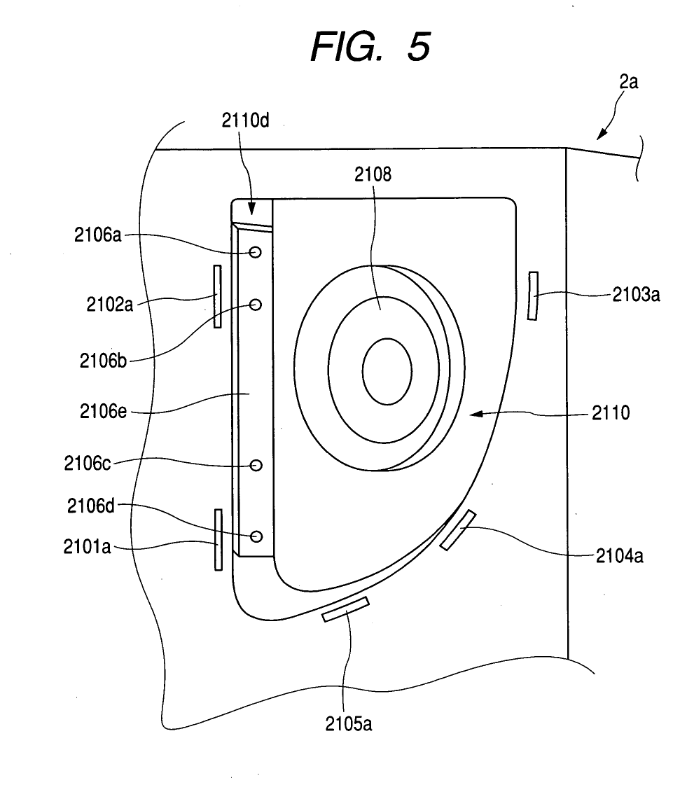

An LED board 2106e is attached to a stepped part 2110d of a recess 2110 where a part of the speaker main unit 2108 is exposed, and white LEDs 2106a to 2106d are disposed on the LED board 2106e (shown in FIG. 5). The face of the stepped part 2110d is roughly perpendicular to the front of the cabinet and the bottom of the recess 2110. The outer periphery of the speaker cover 210 forms roughly a triangle and one longitudinal side of the triangle is longer than one lateral side, so that the LEDs 2106a to 2106d are disposed on the longitudinal side for largely spacing the four LEDs from each other, enhancing the LED light diffusion effect. It is also considered that the LED board 2106e is attached to the oblique line of the triangle; however, the LED board 2106e is attached to the longitudinal side from the viewpoint of difficulty of working and attaching. To set the distance until the LED light arrives at the front of the speaker cover 210 larger than that in the related art and to prevent the player from recognizing point light emission, the LEDs 2106a to 2106d are arranged so that they are not oriented for the front of the speaker cover 210, namely, the LED light does not directly arrive at the front of the speaker cover 210. Here, the direction of the light ray from the LEDs 2106a to 2106d is not a single direction and has an angle of several ten degrees; in the embodiment, the perpendicular direction to the LED board 2106e is the orientation of the LEDs 2106a to 2106d. Attachment holes 2101a to 2105a for fitting attachment projections 2101 to 2105 are made in the outer periphery of the recess 2110. Further, the surface of a part of the cabinet containing the recess 2110 is formed with a mirror surface by applying a process such as metal plating, for reflecting the light from the LEDs 2106a to 2106d on the recess 2110 for complementing the light amount of light emission of the speaker cover 210.

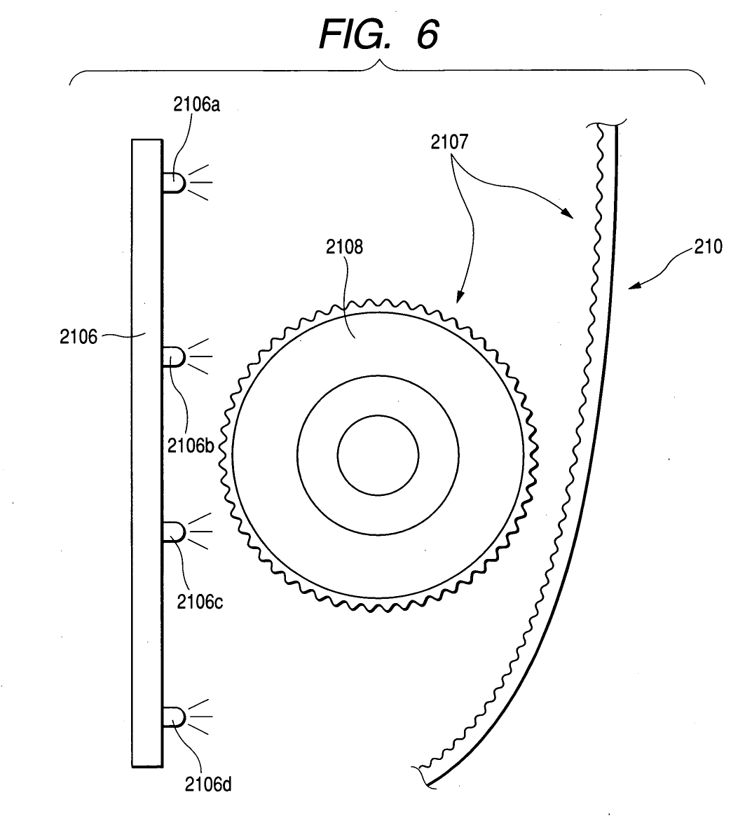

According to the configuration, the light of the LEDs 2106a to 2106d is irregularly reflected and diffused by the asperities 2107 formed on the outer periphery of the inner surface of the speaker cover 210, the front, and the surroundings of the speaker, so that the player is given the impression as if the full face of the speaker cover 210 emitted light (shown in FIG. 6).

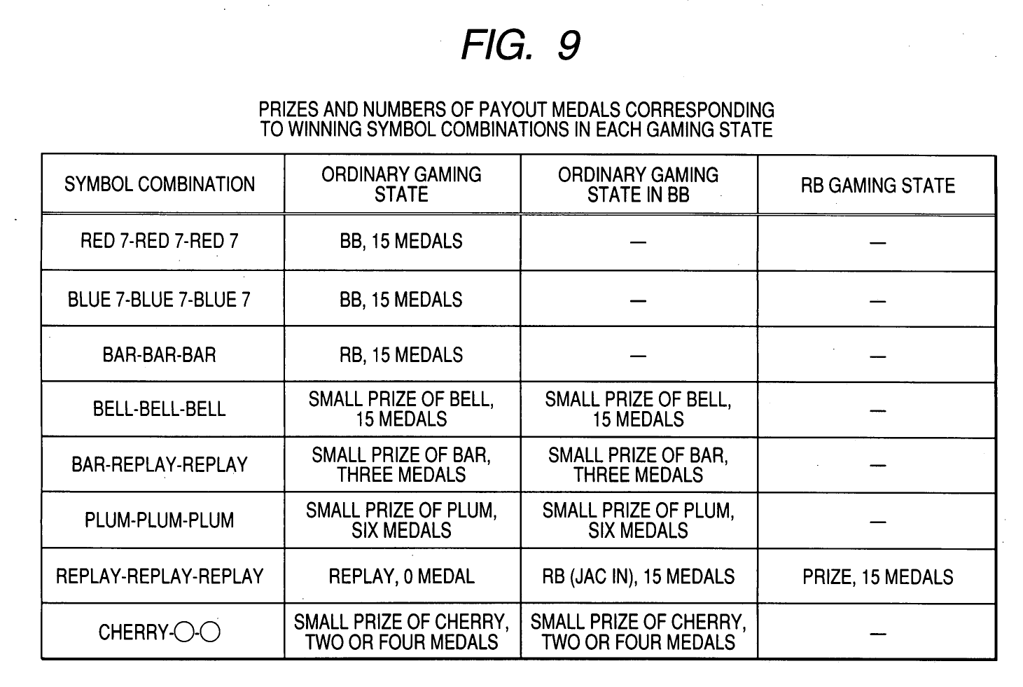

A liquid crystal display 5 having a rectangular 15-inch liquid crystal display screen 5a is provided in front of the panel display unit 2a in FIG. 1. An image can be displayed over the full face of the display screen 5a. The BET lamps 9a, 9b, and 9c, the WIN lamp 17, the payout display unit 18, the credit display unit 19, and the bonus game information display unit 20 are displayed under the control of a main control circuit 71 (shown in FIG. 9) on both outsides of the liquid crystal display screen 5a.

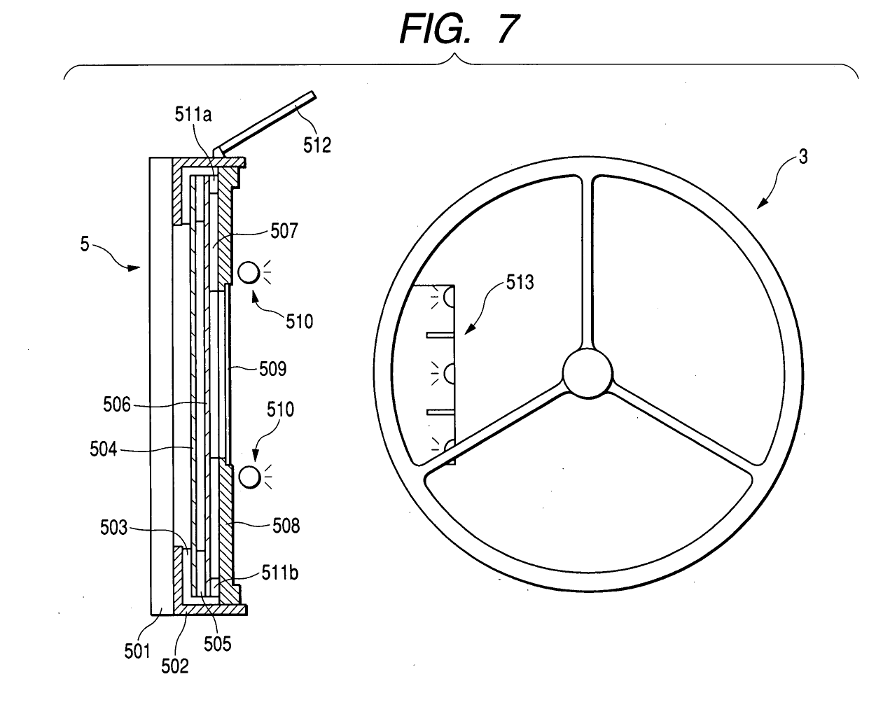

The configuration of the liquid crystal display 5 is as shown in FIG. 7. In FIG. 7, a transparent acrylic plate 501 is provided in front of the liquid crystal display 505, followed by a reel glass base 502, a bezel metal frame 503, liquid crystal 502, a liquid crystal holder 505, a diffuser sheet 506, a light guide plate 507, a rear holder 508, and an antistatic sheet 509 which are stacked in order. The light guide plate 507 is a plate material subjected to special treatment (containing laser beam machining) to uniformly reflect light on the back of a plate such as an acrylic plate. The light guide plate 507 receives light of cold-cathode tube 511a, 511b as light source from the end face, reflecting the light on the rear, and producing uniform surface light emission. The light guide plate 507 and the rear holder 508 are formed with vertically oriented rectangular display windows (4L, 4C, and 4R in FIG. 2). The display windows 4L, 4C, and 4R are visually observed through the liquid crystal display 5. The display driver 512 is disposed in the upper part of the liquid crystal display 5 for causing the cold-cathode tube 511a, 511b to emit light. The antistatic sheet 509 prevents dusts from being deposited on the portion corresponding to the reel window (display window). A fluorescent tube 510 is used as a backlight for the display windows. The display windows 4L, 4C, and 4R receive light from the fluorescent tube 510, reflected light produced as the light from the fluorescent tube 510 is reflected on the surfaces of the reels 3, and light of reel backlights 513 provided for the reels 3. The light enables the player to recognize the liquid crystal 504. The reel backlights 513 each having three longitudinally placed LEDs are provided in a one-to-one correspondence with the reels 3 for illuminating the symbols on the reels 3 from the backs of the reels 3.

The display windows 4L, 4C, and 4R are formed with a top line 8b, a center line 8c, and a bottom line 8d in the horizontal direction and a cross down line 8a and cross up line 8e in the slanting directions as pay lines. As the pay lines, one, three, or five lines are made activated as the player operates a 1-BET switch 11, a 2-BET switch 12, or a MAX-BET switch 13 (described later) or inserts medals into a medal insertion slot 22. Which pay lines are made activated is indicated as a BET lamp 9a, 9b, or 9c (described below) is lighted.

In the cabinet 2, three reels (left reel 3L, center reel 3C, and right reel 3R) each with a symbol row including different types of symbols placed on the outer peripheral surface are provided in a row for rotation, and are contained in symbol row display means. The player can observe the symbols on the reels through the display windows 4L, 4C, and 4R. Each reel rotates at a constant speed (for example, 80 revolutions per minute).

The 1-BET lamp 9a, the 2-BET lamp 9b, the MAX-BET lamp 9c, and a credit display unit 19 are provided on the left of the display windows 4L, 4C, and 4R. The 1-BET lamp 9a, the 2-BET lamp 9b, or the MAX-BET lamp 9c is lighted in response to the number of medals bet to play one game, which will be hereinafter referred to as the BET count.

In the embodiment, one game is over when all reels stop. When the BET count is 1 and one pay line is made activated, the 1-BET lamp 9a is lighted; when the BET count is 2 and three pay lines are made activated, the 2-BET lamp 9b is lighted; and when the BET count is 3 and all the five pay lines are made activated, the MAX-BET lamp 9c is lighted. The credit display unit 19 is made up of seven-segment LEDs for displaying the deposited number of medals.

The WIN lamp 17 and the payout display unit 18 are provided on the right of the display windows 4L, 4C, and 4R. The WIN lamp 17 is lighted when the winning game of BB or RB is complete. It is lighted at a predetermined probability when the internal winning is accepted as BB or RB. The payout display unit 18 is made up of seven-segment LEDs for displaying the number of medals paid out when the winning game is complete.

The bonus game information display unit 20 is provided in the upper right corner of the display screen 5a of the panel display unit 2a. The bonus game information display unit 20 is made up of seven-segment LEDs for displaying the number of RB games that can be played, and the possible number of winning games of RB (described later).

A frontward projection portion 10 of a horizontal plane is formed below the display screen 5a. The display screen 5a displays not only the various lamps and the various display units, but also various effects of animation and the “operation order” required for realizing completion of the winning game when the internal winning of “small prize of bell” is accepted in the “assistance time period.”

The medal insertion slot 22 is provided at the right end of the frontward projection portion 10, and the 1-BET switch 11, the 2-BET switch 12, and the MAX-BET switch 13 are provided at the left end of the frontward projection portion 10. The 1-BET switch 11 enables the player to bet one of the credited medals by one push operation on a game. The 2-BET switch 12 enables the player to bet two of the credited medals by one push operation on a game. The MAX-BET switch 13 enables the player to bet as many medals as the maximum number of medals that can be bet on a game by one push operation. As the player operates any of the BET switches, the corresponding pay lines are made activated as described above.

A C/P switch 14 for the player to switch between credit and payout of the medals obtained by playing games by push button operation is provided on the left of the front of the frontward projection portion 10. As the C/P switch 14 is switched, medals are paid out from a medal payout opening 15 in a lower part of the front and are stored in a game play medal tray 16.

On the right of the C/P switch 14, a start lever 6 (contained in start operation means) for rotating the reels for starting variable display of symbols in the display windows 4L, 4C, and 4R (starting a game) as the player operates the start lever 6 is attached so that it can be turned in a predetermined angle range.

Three stop buttons (left stop button 7L, center stop button 7C, and right stop button 7R) as operation buttons contained in stop operation means for stopping rotation of the three reels 3L, 3C, and 3R are provided at the center of the front of the frontward projection portion 10 and below the display screen 5a.

In the embodiment, the stop operation performed by the player pushing the first stop button when all reels rotate is called “first stop operation,” the stop operation next performed by the player pushing the second stop button is called “second stop operation,” and the stop operation performed by the player pushing the third stop button following the second stop operation is called “third stop operation.”

Since the pinball slot machine 1 of the embodiment is provided with the three stop buttons 7L, 7C, and 7R, there are six different operation orders of the stop buttons. Then, the operation orders are distinguished from each other as follows: The left stop button 7L is abbreviated to “left,” the center stop button 7C to “center,” and the right stop button 7R to “right.”

To indicate the operation order, the abbreviations of the stop buttons 7L, 7C, and 7R are listed from left to right in the stop operation order. For example, when the player operates the left stop button 7L as the first stop operation, the center stop button 7C as the second stop operation, and the right stop button 7R as the third stop operation, the operation order is indicated as “left center right.” In the embodiment, the six different operation orders of “left center right,” “left right center,” “center left right,” “center right left,” “right left center,” and “right center left” are available.

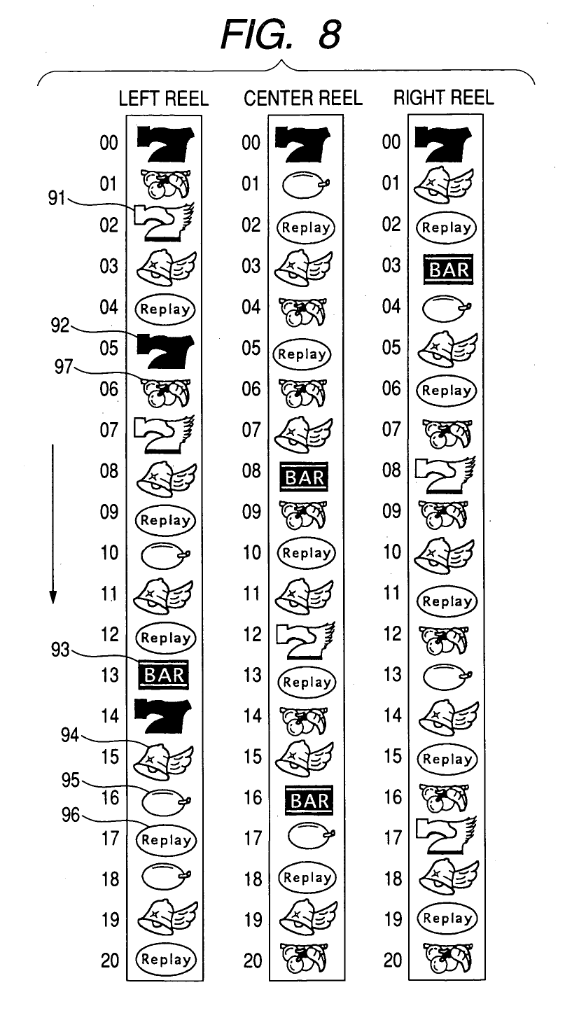

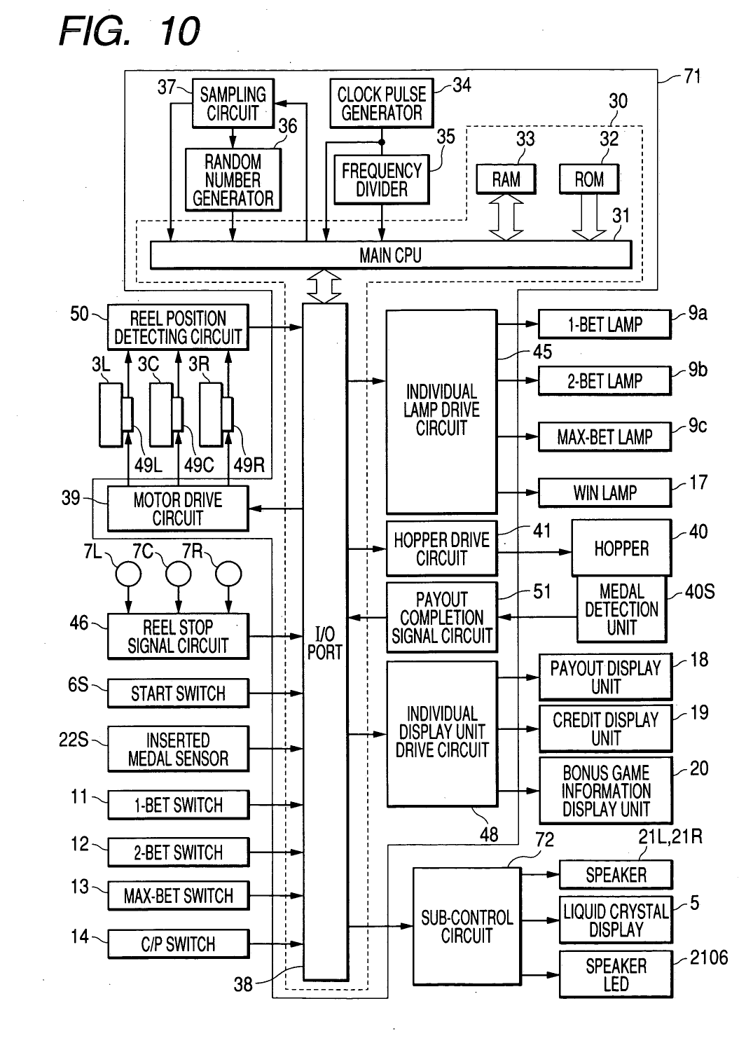

FIG. 8 shows symbol rows each made up of 21 symbols represented on each reel 3L, 3C, 3R. The symbols are given code numbers “00” to “20” and are stored in ROM 32 (shown in FIG. 10) described later as a data table.

The symbol rows each made up of symbols of “blue 7 (symbol 91),” “red 7 (symbol 92),” “BAR (symbol 93),” “bell (symbol 94),” “plum (symbol 95),” “Replay (symbol 96),” and “cherry (symbol 97)” are represented on the reels 3L, 3C, and 3R. The reels 3L, 3C, and 3R are rotated so that the symbol rows move in the arrow direction in FIG. 4.

FIG. 9 shows the prizes and the numbers of paid-out medals corresponding to the winning symbol combinations in each gaming state.

The gaming state generally is classified depending on whether or not the internal winning of BB or RB is accepted or whether or not BB or RB operates. The types of prizes having the possibility of accepting internal winning are determined according to a probability lottery table; generally, the probability lottery table is provided for each gaming state.

That is, the types of prizes having the possibility of accepting internal winning become the same for games in the same gaming state. However, BB gaming state contains ordinary gaming state in BB and RB gaming state and contains the state in which the types of prizes having the possibility of accepting internal winning differ.

As shown in FIG. 9, when “blue 7-blue 7-blue 7” or “red 7-red 7-red 7” is placed in a row along the activated line in the ordinary gaming state, a winning game of BB is complete and 15 medals are paid out to the player and the gaming state of the next game enters the BB gaming state.

The RB gaming state occurs when the symbol combination along the activated line is “BAR-BAR-BAR” in the ordinary gaming state or when the symbol combination along the activated line is “Replay-Replay-Replay” in the ordinary gaming state in BB (JAC IN). At this time, 15 medals are paid out to the player.

The RB gaming state is a gaming state in which the player easily gains a prize of paying out 15 medals to the player with completion of the predetermined symbol combination “Replay-Replay-Replay” as the player bets one medal.

The maximum number of games that can be played by the player in one RB gaming state (the number of RB games that can be played) is 12. The number of winning games that can be gained in the RB gaming state (the possible number of winning games of RB) is up to eight. That is, the RB gaming state exits if the number of games reaches 12 or if the number of winning games reaches eight.

The BB gaming state exits when the player performs the third stop operation in a predetermined game. For example, when the player performs the third stop operation in the last game in the third RB gaming state, the BB gaming state exits.

When the symbol combination along the activated line is “Replay-Replay-Replay” in the ordinary gaming state, a winning game of replay is complete. When a winning game of replay is complete, as many medals as the number of inserted medals are automatically inserted, so that the player can play a game without consuming medals.

As symbol combination “bell-bell-bell” is placed in a row along the activated line in the ordinary gaming state or the ordinary gaming state in BB, a winning game of small prize of bell is complete. When the internal winning of small prize of bell is accepted, whether or not the winning game is complete is determined by the table number (described later) and the operation order of the stop buttons 7L, 7C, and 7R by the player.

Specifically, the symbol combination “bell-bell-bell” is placed in a row along the activated line and the winning game of small prize of bell is complete only if the player operates the stop buttons 7L, 7C, and 7R in the operation order of the six operation orders corresponding to the table number. If the player operates the stop buttons 7L, 7C, and 7R in any order other than the operation order corresponding to the table number, the winning game of small prize of bell becomes incomplete.

It is possible to realize completion of winning games of “small prize of cherry,” “small prize of BAR,” and “small prize of plum” in the ordinary gaming state or the ordinary gaming state in BB. The numbers of medals paid out to the player are as shown in the figure.

In the ordinary gaming state, when the internal winning of small prize of bell is accepted, time period (assistance time period or AT) is provided for notifying the player of the operation order for realizing completion of the winning game. When the internal winning of small prize of bell is accepted in the time period, the player can surely realize completion of the winning game.

There are two assistance time period lottery conditions. The first lottery condition is when the internal winning of small prize of plum is accepted and the state is the ordinary gaming state. The second lottery condition is when the internal lottery is a blank in the assistance time period or concealment time period (described later). As either lottery condition is satisfied, assistance time period lottery processing (AT lottery processing) described later is performed.

The assistance time period is made up of a plurality of successive games, which will be hereinafter referred to as a set. Lottery as to the number of games in one set and the number of sets to be generated is held in the assistance time period lottery processing. The number of sets that can be generated is referred to as the number of sets. If the assistance time period lottery processing is performed in the assistance time period or the concealment time period and prize in the lottery is won, the number of sets is accumulated.

Whether or not the assistance time period is to be generated (actualized) is determined in assistance time period activation processing (AT activation processing) described later. The time period having the possibility that the assistance time period will occur after the lottery condition is satisfied and prize in the AT lottery is won (specifically, the time period in which the value of a number-of-sets counter (described later) is one or more in the ordinary gaming state and which is not the assistance time period) will be hereinafter referred to as the concealment time period. The time period other than the assistance time period or the concealment time period will be hereinafter referred to as the usual time period.

FIG. 10 shows the circuit configuration including the above-mentioned main control circuit 71 (contained in internal lottery means) for controlling the game processing operation of the pinball slot machine 1, peripherals (actuators) electrically connected to the main control circuit 71, and a sub-control circuit 72 for controlling the speaker LEDs 2106, the liquid crystal display 5, and the speakers 21L and 21R based on a control command transmitted from the main control circuit 71.

The main control circuit 71 is made up of the microcomputer 30 placed on the circuit board as the main component and a random number sampling circuit. The microcomputer 30 includes a CPU 31 for performing the control operation in accordance with a preset program, and ROM 32 and RAM 33, both of which are provided as a storage.

Connected to the CPU 31 are a clock pulse generation circuit 34 for generating a reference clock pulse, a frequency divider 35, a random number generator 36 for generating sampled random numbers, and a sampling circuit 37.

For sampling random numbers, random number sampling may be executed in the microcomputer 30, namely, the operation program of the CPU 31. In this case, the random number generator 36 and the sampling circuit 37 can be omitted or can also be left for backup of the random number sampling operation.

The ROM 32 of the microcomputer 30 stores probability lottery tables used to determine random number sampling performed each time the player operates the start lever 6 (start operation), stop control tables for determining the reel stop mode in response to operation of the stop buttons, various control commands to be transmitted to the sub-control circuit 72, and the like.

The commands include a standby screen command and a start command. The sub-control circuit 72 does not input commands and information to the main control circuit 71 and one-way communications are conducted from the main control circuit 71 to the sub-control circuit 72.

In the circuitry in FIG. 10, the main actuators whose operation is controlled by a control signal from the microcomputer 30 include the various lamps (1-BET lamp 9a, 2-BET lamp 9b, MAX-BET lamp 9c, and WIN lamp 17), the various display units (payout display unit 18, credit display unit 19, and bonus game information display unit 20), a hopper (containing a drive section for paying out medals) 40 as game play value giving means for storing medals and paying out a predetermined number of medals according to an instruction of a hopper drive circuit 41, and stepping motors 49L, 49C, and 49R for rotating the reels 3L, 3C, and 3R.

Further, a motor drive circuit 39 for driving and controlling the stepping motors 49L, 49C, and 49R, a hopper drive circuit 41 for driving and controlling the hopper 40, a individual lamp drive circuit 45 for driving and controlling the various lamps, and a individual display unit drive circuit 48 for driving and controlling the various display units are connected to the output section of the CPU 31 through an I/O port 38. Each of these drive circuits receives a control signal such as a drive command output from the CPU 31 and controls the operation of the corresponding actuator.

The main input signal generation means for generating an input signal required for generating a control command by the microcomputer 30 include a start switch 6S, the 1-BET switch 11, the 2-BET switch 12, the MAX-BET switch 13, the C/P switch 14, a game assistance switch 99, an inserted medal sensor 22S, a reel stop signal circuit 46, a reel position detecting circuit 50, and a payout completion signal circuit 51. These are also connected to the CPU 31 through the I/O port 38.

The start switch 6S detects the player operating the start lever 6. The inserted medal sensor 22S detects a medal inserted to the medal insertion slot 22. The reel stop signal circuit 46 generates a stop signal as the player operates each stop button 7L, 7C, 7R. The reel position detecting circuit 50 receives a pulse signal from a reel rotation sensor and supplies a signal for detecting the position of each reel 3L, 3C, 3R to the CPU 31. The payout completion signal circuit 51 generates a signal for detecting completion of medal payout when the count of a medal detection section 40S (the number of medals paid out from the hopper 40) reaches the specified number of medals.

In the circuitry in FIG. 10, the random number generator 36 generates random numbers contained in a given numeric value range and the sampling circuit 37 samples one random number at the appropriate timing after the player starts the start lever 6. The CPU 31 determines the internal winning combination based on the random number thus sampled and the probability lottery table stored in the ROM 32. Therefore, the CPU 31 implements winning state determination means for determining the winning state of the game, namely, the internal winning combination by random number lottery.

After rotation of each of the reels 3L, 3C, and 3R is started, the number of drive pulses supplied to each of the stepping motors 49L, 49C, and 49R and the counts are written into a predetermined area of the RAM 33. A reset pulse is obtained every revolution of the reel 3L, 3C, 3R and the reset pulses are input to the CPU 31 through the reel position detecting circuit 50. The drive pulse counts written in the RAM 33 are cleared to 0 according to the reset pulses thus obtained. Accordingly, the counts corresponding to the rotation positions of the reels 3L, 3C, and 3R within the range of one revolution are stored in the RAM 33.

A symbol table is stored in the ROM 32 to relate the rotation positions of the reels 3L, 3C, and 3R and the symbols drawn on the outer peripheral surfaces of the reels to each other. In the symbol table, the code numbers given in sequence every given rotation pitch of each reel 3L, 3C, 3R based on the rotation position where the reset pulse is generated and the symbol codes indicating the symbols provided in one-to-one correspondence with the code numbers are related to each other.

Further, a winning symbol combination table is stored in the ROM 32. The winning symbol combination table lists the symbol combinations of winning games, the numbers of paid-out medals for the winning games, and the winning game determination codes representing the winning games in association with each other. The winning symbol combination table is referenced at the stop control time of the left reel 3L, the center reel 3C, the right reel 3R and when the winning game is confirmed after all reels are stopped.

If the internal winning is accepted according to lottery processing based on the random number sampling (probability lottery processing), the CPU 31 sends the stop control signal of the reels 3L, 3C, and 3R to the motor drive circuit 39 based on the operation signal sent from the reel stop signal circuit 46 at the timing at which the player operates the stop buttons 7L, 7C, and 7R, and the selected stop control table. The CPU 31 functions as stop control means for performing stop control of the reels 3L, 3C, and 3R.

When the player pushes the stop button 7L, 7C, 7R, the stop control table is referenced and is used to determine the stop position of the reel.

Specifically, when the player pushes the stop button 7L, 7C, 7R, the symbol positioned on the center line 8c on the reel corresponding to the operated stop button (specifically, the symbol whose center is positioned above the center line 8c and is nearest to the position of the center line 8c) is detected, the code number of the symbol (operation position) is collated with the stop control table, and the code number of the symbol to be stopped at the position of the center line 8c (stop position) is determined.

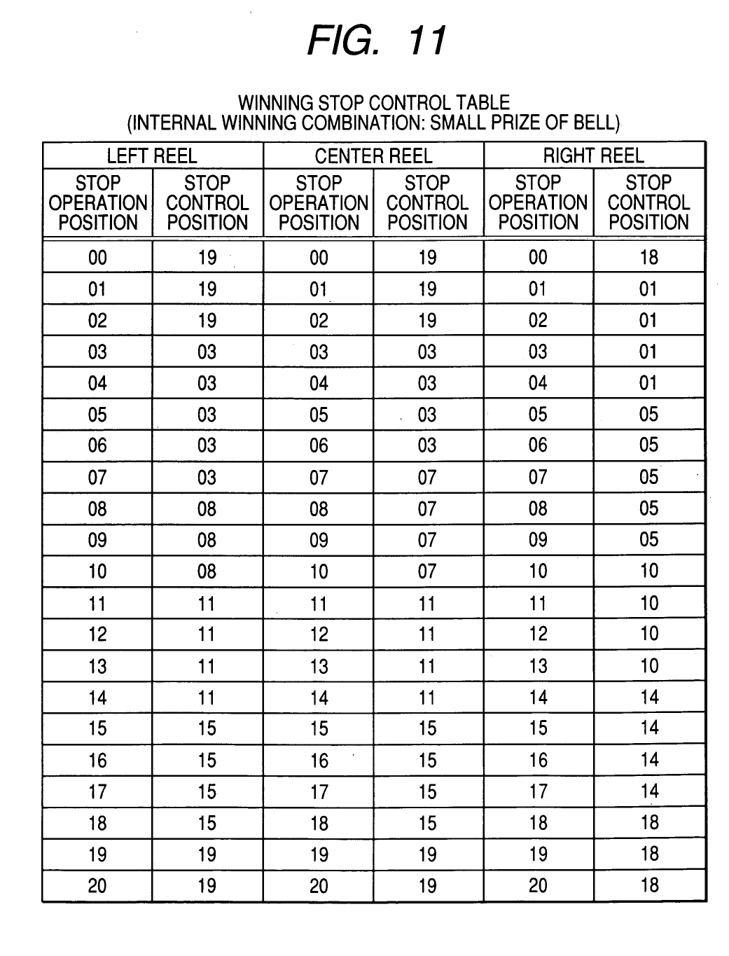

The stop control table used when the internal winning of small prize of bell is accepted will be discussed with reference to FIGS. 11 through 13.

The stop control table lists the stop operation positions and the stop control positions of the reels 3L, 3C, and 3R. The stop operation position represents the code number of the symbol positioned on the center line 8c (specifically, the symbol whose center is positioned above the center line 8c and is nearest to the position of the center line 8c) when the player operates the stop button 7L, 7C, 7R provided corresponding to the reel 3L, 3C, 3R. The stop control position represents the code number of the symbol stopped and displayed at the position of the center line 8c when each of the reels stopped by the player actually stops. In the embodiment, the number of slide frames is four at the maximum. For example, when “cherry” with code number 12 (symbol 97 in FIG. 8) arrives at the position of the center line 8c while the right reel 3R is rotating, if the player operates the stop button 7R, stop control of the right reel 3R can be performed so as to stop and display “blue 7” with code number 8 (symbol 91 in FIG. 8) at the position of the center line 8c.

FIG. 11 shows a winning stop control table. This table is used when stop control of the reels is performed so that “bell-bell-bell” is placed in a row along the activated line and the winning game of small prize of bell is complete after the internal winning of small prize of bell is accepted.

In FIG. 11, the stop control position of the left reel 3L is any of code number “03”, “08”, “11”, “15”, or “19”. In the symbol row shown in FIG. 8, the symbols corresponding to these code numbers are bell (symbol 94).

In FIG. 11, the stop control position of the center reel 3C is any of code number “03”, “07”, “11”, “15”, or “19”. In the symbol row shown in FIG. 8, the symbols corresponding to these code numbers are bell (symbol 94).

In FIG. 11, the stop control position of the right reel 3R is any of code number “01”, “05”, “10”, “14”, or “18”. In the symbol row shown in FIG. 8, the symbols corresponding to these code numbers are bell (symbol 94).

If the winning stop control table shown in FIG. 11 is thus used for stop control of the reels 3L, 3C, and 3R, “bell-bell-bell” is stopped and displayed at the position of the center line 8c, namely, at the centers of the display windows 4L, 4C, and 4R, and the winning game is complete.

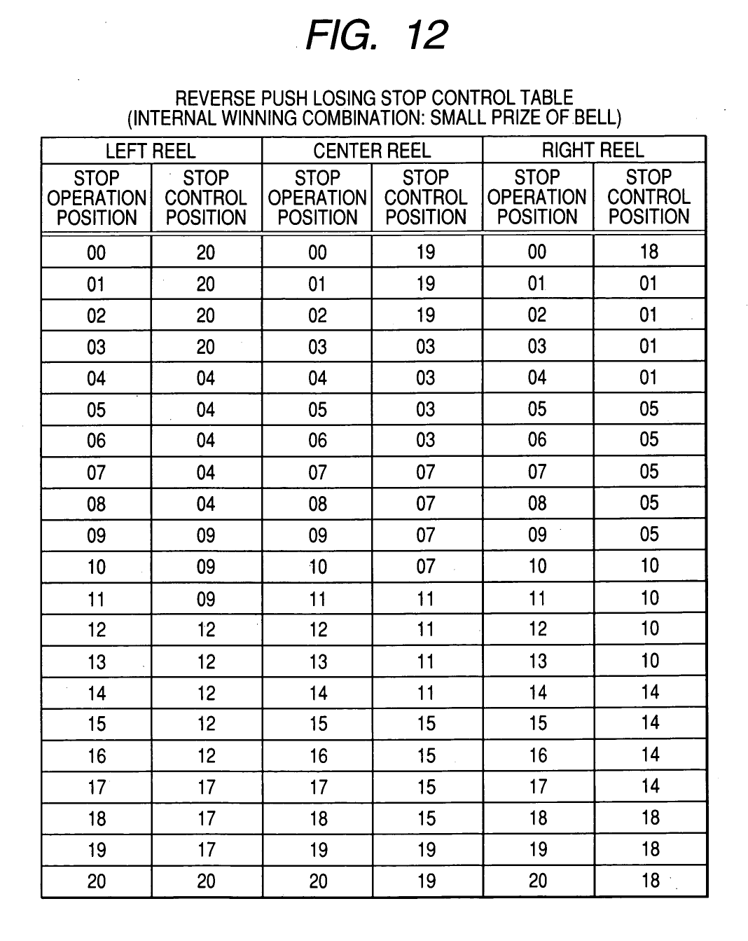

FIG. 12 shows a forward push (left center right), center push (center left right) losing stop control table. This table is used when stop control of the reels is performed so that “bell-bell-bell” is not placed in a row along the activated line (the winning game of small prize of bell is incomplete) after the internal winning of small prize of bell is accepted. The stop control positions corresponding to the stop operation positions of the left reel 3L and the center reel 3C are the same as those shown in FIG. 11.

In FIG. 12, the stop control position of the right reel 3R is any of code number “02”, “06”, “11”, “15”, or “19”. In the symbol row shown in FIG. 8, the symbols corresponding to these code numbers are “Replay (symbol 96).”

If the forward push, center push losing stop control table shown in FIG. 12 is thus used for stop control of the reels 3L, 3C, and 3R, “bell-bell” is stopped and displayed at the centers of the display windows 4L and 4C, and “Replay” is stopped and displayed at the center of the display window 4R and thus the winning game of small prize of bell becomes incomplete.

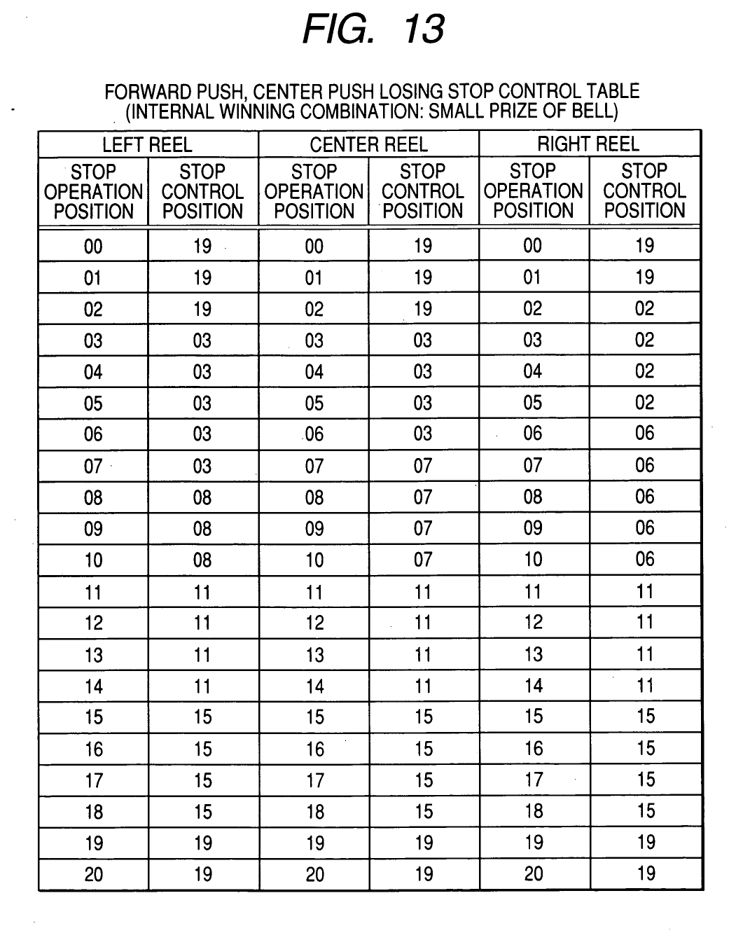

FIG. 13 shows a reverse push (right center left) losing stop control table. The reverse push losing stop control table is used when stop control of the reels is performed so that “bell-bell-bell” is not placed in a row along the activated line (the winning game of small prize of bell is incomplete) after the internal winning of small prize of bell is accepted. The stop control positions corresponding to the stop operation positions of the center reel 3C and the right reel 3R are the same as those shown in FIG. 11.

In FIG. 13, the stop control position of the left reel 3L is any of code number “04”, “09”, “12”, “17”, or “20”. In the symbol row shown in FIG. 8, the symbols corresponding to these code numbers are “Replay (symbol 96).”

If the reverse push losing stop control table shown in FIG. 13 is thus used for stop control of the reels 3L, 3C, and 3R, “Replay” is stopped and displayed at the center of the left display window 4L and “bell-bell” is stopped and displayed at the centers of the display windows 4C and 4R, and thus the winning game of small prize of bell becomes incomplete.

The number of slide frames described above indicates the number of symbols moved until the reel stops after the player operates the stop button and is represented by the absolute value of the difference between the operation position in the stop control table (the code number of the symbol positioned on the center line when the player operates the stop button) and the stop position (the code number of the symbol stopped on the center line when the reel actually stops).

The number of slide frames may be called the number of pulled-in frames.” In the embodiment, the number of slide frames is four at the maximum. For example, when “cherry” with code number 12 (symbol 97 in FIG. 8) arrives at the position of the center line 8c while the right reel 3R is rotating, if the player operates the stop button 7R, stop control of the right reel 3R can be performed so as to stop and display “blue 7” with code number 08 (symbol 91 in FIG. 8) at the position of the center line 8c.

On the other hand, in the stop mode indicating completion of the winning game of internal winning combination, the CPU 31 supplies a payout command signal to the hopper drive circuit 41 for paying out a predetermined number of medals to the player from the hopper 40.

At the time, the medal detection section 40S counts the number of medals paid out from the hopper 40. When the count reaches the specified number of medals, a medal payout completion signal is input to the CPU 31, which then stops driving the hopper 40 through the hopper drive circuit 41 and terminates the medal payout processing.

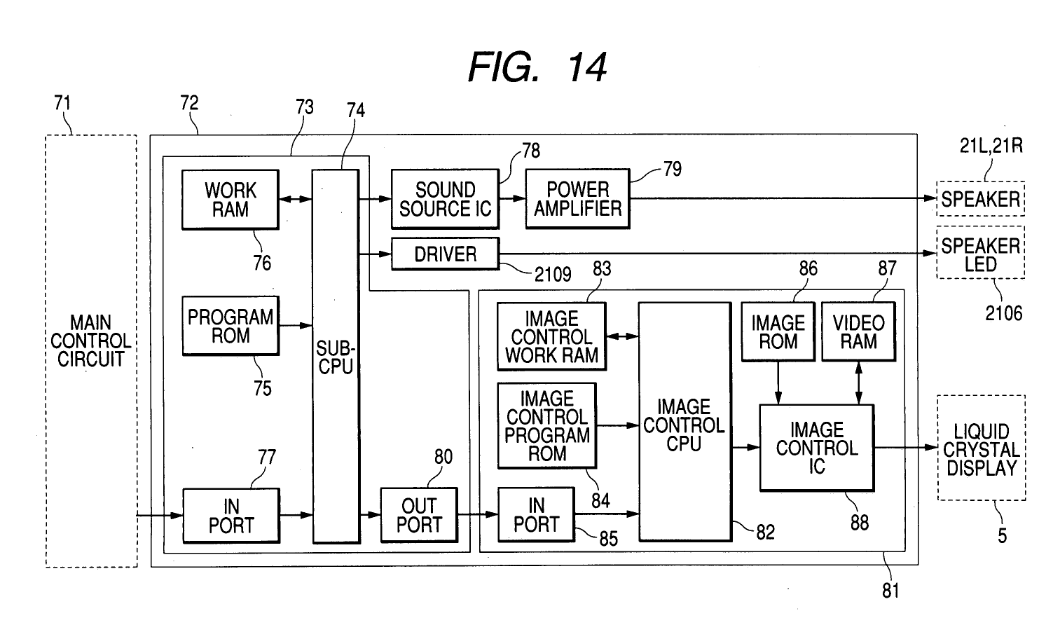

FIG. 14 shows the configuration of the sub-control circuit 72. The sub-control circuit 72 performs display control of the liquid crystal display 5, output control of sound from the speakers 21L and 21R, and lighting control of the speaker LEDs 2106 (LEDs 2106a to 2106d) based on the control commands from the main control circuit 71. The sub-control circuit 72, which is implemented on a separate circuit board from the circuit board implementing the main control circuit 71, is made up of a microcomputer (sub-microcomputer) 73 as the main component, an image control circuit 81 as display control means of the liquid crystal display 5, a sound source IC 78 for controlling sound output from the speakers 21L and 21R, a power amplifier 79, and a driver 2109 as lighting control means of the speaker LEDs 2106.

The sub-microcomputer 73 includes a sub-CPU 74 for performing the control operation following a control command transmitted from the main control circuit 71, program ROM 75 as storage means, and work RAM 76. The signal from the main control circuit 71 to the sub-microcomputer 73 is input through an IN port 77, and the signal to the image control circuit 81 is output through an OUT port 80.

The sub-control circuit 72 does not include a clock pulse generation circuit, a frequency divider, a random number generator, or a sampling circuit, but executes random number sampling in an operation program of the sub-CPU 74. Generation of the assistance time period is determined as the random number sampling is executed.

The sub-CPU 74 includes the number-of-AT-sets counter and a number-of-AT-games counter. The number-of-AT-sets counter stores the number of sets. The number-of-AT-games counter stores information concerning the number of games in one assistance time period.

The program ROM 75 stores a control program executed in the sub-CPU 74. The work RAM 76 is used as temporary storage means for the sub-CPU 74 to execute the control program.

The image control circuit 81 is made up of an image control CPU 82, an image control work RAM 83, image control program ROM 84, image ROM 86, video RAM 87, and an image control IC 88. The image control CPU 82 determines the display contents on the liquid crystal display 5 in accordance with an image control program stored in the image control program ROM 84 based on the parameters set in the sub-microcomputer 73. The signal from the sub-CPU 74 is input through an IN port 85.

The image control program ROM 84 stores the image control program involved in display on the liquid crystal display 5 and various selection tables. The image control work RAM 83 is used as temporary storage means for the image control CPU 82 to execute the image control program. The image control IC 88 forms an image responsive to the display contents determined by the image control CPU 82 and outputs the image to the liquid crystal display 5. The image ROM 86 stores dot data for forming an image. The video RAM 87 is used as temporary storage means for the image control IC 88 to form an image.

On the other hand, the sub-CPU 74 displays an image on the liquid crystal display 5 based on the command signal from the CPU 31.

Specifically, whenever a stop signal is input from the reel stop signal circuit 46 as the player operates the start lever 6 or the stop button 7L, 7C, 7R, the sub-CPU 74 transmits a signal to the image control CPU 82 and displays an image on the display screen 5a of the liquid crystal display 5.

In the embodiment, the CPU 31, the liquid crystal display 5, the sub-CPU 74, and the image control CPU 82 make up display means.

Thus, the pinball slot machine 1 (contained in gaming machine) according to the first embodiment of the invention includes the main control circuit 71 (contained in internal lottery means) for holding internal lottery of game using a random number at a predetermined timing, the speakers 21L and 21R (contained in sound output means) each having a part exposed to the front of the cabinet of the pinball slot machine 1 for outputting sound toward the front, the LED boards 2106 and the LEDs 2106a to 2106d (contained in light emission means) being placed away from the exposed parts of the speakers 21L and 21R and attached to the cabinet of the pinball slot machine 1 for emitting light, and the speaker covers 210 (contained in cover) being provided so as to surround the exposed parts of the speakers 21L and 21R and cover the LED boards 2106 and the LEDs 2106a to 2106d. The LEDs 2106a to 2106d (contained in light source of light emission means) are oriented so as to be substantially parallel with the front of the cabinet of the pinball slot machine 1 and thus is placed in a sideways position relative to the front of the gaming machine, and the LED light is reflected within the speaker cover 210 and gets indirectly to the player. Therefore, the player is given the impression as if the full face of the speaker cover 210 emitted light, and the high illumination effect can be provided. The LED is small as compared with a lamp and thus the player does not feel that the light emission is point light emission, and the energy saving effect can also be expected.

In the description of the first embodiment, the speaker cover 210 is formed on the inner surface (back) with the asperities 2107. In the invention, if the speaker cover 210 is formed on the inner surface with continuous steps (containing stepped shape), similar advantages can also be provided. Alternatively, if a diffusion sheet (containing a prism sheet) is provided in the speaker cover 210, similar advantages can also be provided.

In the description of the first embodiment, the speaker cover 210 is formed on the inner surface (back) with the asperities 2107. In addition, in the invention, the speaker cover 210 may be formed on the outside (surface) with a lens face. In this case, the effect of further diffusing light irregularly reflected on the asperities 2107 can be provided.

In the description of the first embodiment, the perpendicular direction to the LED board 2106e is the orientation of the LEDs 2106a to 2106d. In the invention, if any direction other than the perpendicular direction to the LED board 2106e is the orientation of the LEDs 2106a to 2106d, similar advantages can also be provided.

Further, in the description of the first embodiment, the LED board 2106e is attached to a part of the stepped part 2110d of the recess 2110 in which the speaker main unit 2108 is embedded. In the invention, if the LED board 2106e is attached to the full peripheral surface of the stepped part 2110d or if the stepped part 2110d is formed with a belt-like groove deeper than the thickness of the LED board 2106e and the LED 2106a to 2160d and wider than the width of the LED board 2106e is formed and the LED board 2106e is attached to the groove, similar advantages can also be provided.

### Second Embodiment

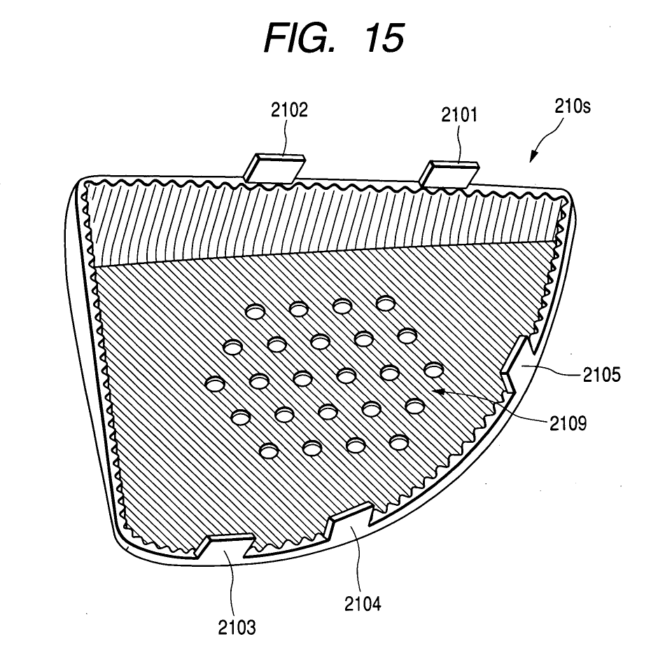

A pinball slot machine according to a second embodiment of the invention is almost the same as that according to the first embodiment except for speaker cover 210s and therefore components identical with those previously described with reference to FIGS. 1 through 5 are denoted by the same reference numerals in FIG. 15 and will not be discussed again.

FIG. 15 shows a speaker cover (back) in the second embodiment of the invention. Here, a speaker 21R will be discussed. The configuration of a speaker 21L is also similar to that of the speaker 21R and therefore the configuration of the speaker 21L is not shown and will not be discussed.

The speaker 21R has a speaker main unit 2108 (shown in FIG. 5) embedded in a cabinet and a transparent or semitransparent resin speaker cover 210s for covering the speaker main unit 2108 (shown in FIG. 15). The speaker cover 210s is formed in an outer margin with attachment projections 2101 to 2105. A plurality of holes 2109 for allowing an acoustic wave produced by vibration of a vibration plate of the speaker main unit 2108 to pass through are made in the cover front opposed to the exposed part of the speaker main unit 2108. Further, the speaker cover 210s is formed on an inner surface with asperities for diffusing light (corresponding to 2107 in FIG. 4) except for the plurality of holes 2109.

In the cabinet, an LED board 2106e is attached to a stepped part 2110d of a recess 2110 where a part of the speaker main unit 2108 is exposed, as in the first embodiment, and white LEDs 2106a to 2106d are disposed on the LED board 2106e (shown in FIG. 5). Here, the face of the stepped part 2110d is roughly perpendicular to the front of the cabinet and the bottom of the recess 2110. The outer periphery of the speaker cover 210s forms roughly a triangle and one longitudinal side of the triangle is longer than one lateral side, so that the LEDs 2106a to 2106d are disposed on the longitudinal side for largely spacing the four LEDs from each other, enhancing the LED light diffusion effect. It is also considered that the LED board 2106e is attached to the oblique line of the triangle. However, the LED board 2106e is attached to the longitudinal side from the viewpoint of difficulty of working and attaching. To set the distance until the LED light arrives at the front of the speaker cover 210s larger than that in the related art and to prevent the player from recognizing point light emission, the LEDs 2106a to 2106d are arranged so that they are not oriented for the front of the speaker cover 210s, namely, the LED light does not directly arrive at the front of the speaker cover 210s. Here, the direction of the light ray from the LEDs 2106a to 2106d is not a single direction and has an angle of several ten degrees; in the embodiment, the perpendicular direction to the LED board 2106e is the orientation of the LEDs 2106a to 2106d. Attachment holes 2101a to 2105a for fitting attachment projections 2101 to 2105 are made in the outer periphery of the recess 2110. Further, the surface of a part of the cabinet containing the recess 2110 is formed with a mirror surface by metal plating, etc., for reflecting the light from the LEDs 2106a to 2106d on the recess 2110 for complementing the light amount from the speaker cover 210s.

According to the configuration, the light of the LEDs 2106a to 2106d is diffused as the light is irregularly reflected by the asperities 2107 formed on the outer periphery of the inner surface of the speaker cover 210s and the front and passes through the speaker cover 210s, so that the player is given the impression as if the full face of the speaker cover 210s emitted light. Particularly, the asperities 2107 are also formed in the portion of the cover front opposed to the exposed part of the speaker main unit 2108, so that the effect of diffusing the LED light is furthermore enhanced.

In the description of the second embodiment, the speaker cover 210s is formed on the inner surface (back) with the asperities 2107. In the invention, if the speaker cover 210s is formed on the inner surface with continuous steps (containing stepped shape), similar advantages can also be provided. Alternatively, if a diffusion sheet (containing a prism sheet) is provided in the speaker cover 210s, similar advantages can also be provided.

In the description of the second embodiment, the speaker cover 210s is formed on the inner surface (back) with the asperities 2107. In addition, in the invention, the speaker cover 210s may be formed on the outside (surface) with a lens face. In this case, the effect of further diffusing light irregularly reflected on the asperities 2107 can be provided.

In the description of the second embodiment, the perpendicular direction to the LED board 2106e is the orientation of the LEDs 2106a to 2106d. In the invention, if any direction other than the perpendicular direction to the LED board 2106e is the orientation of the LEDs 2106a to 2106d, similar advantages can also be provided.

Further, in the description of the second embodiment, the LED board 2106e is attached to a part of the stepped part 2110d of the recess 2110 in which the speaker main unit 2108 is embedded. In the invention, if the LED board 2106e is attached to the full peripheral surface of the stepped part 2110d or if the stepped part 2110d is formed with a belt-like groove deeper than the thickness of the LED board 2106e and the LED 2106a to 2160d and wider than the width of the LED board 2106e is formed and the LED board 2106e is attached to the groove, similar advantages can also be provided.

### Third Embodiment

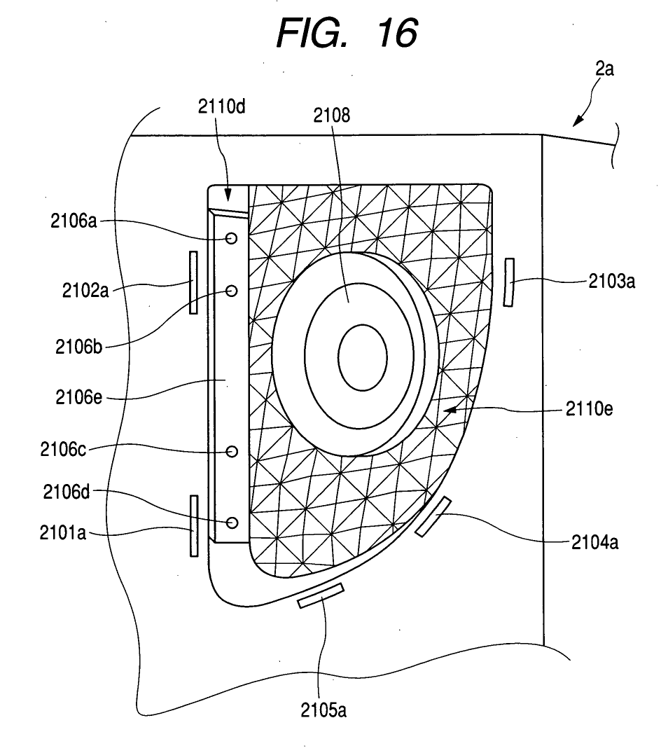

A pinball slot machine according to a third embodiment of the invention is almost the same as that according to the first embodiment except for bottom part 2110e of recess where a part of speaker main unit is exposed in cabinet and therefore components identical with those previously described with reference to FIGS. 1 to 6 are denoted by the same reference numerals in FIG. 16 and will not be discussed again.

FIG. 16 shows the vicinity of a speaker on one side of a cabinet in the third embodiment of the invention. Hereinafter, a speaker 21R will be discussed. The configuration of a speaker 21L is also similar to that of the speaker 21R and therefore the configuration of the speaker 21L is not shown and will not be discussed.

The speaker 21R has a speaker main unit 2108 embedded in the cabinet as in the first embodiment and a transparent or semitransparent resin speaker cover 210 for covering the speaker main unit 2108 (shown in FIG. 4). The speaker cover 210 is formed in an outer margin with attachment projections 2101 to 2105. Further, the speaker cover 210 is formed on an inner surface with asperities 2107 for diffusing light (shown in FIG. 6).

In the cabinet, an LED board 2106e is attached to a stepped part 2110d of a recess (corresponding to 2110 in FIG. 5) where a part of the speaker main unit 2108 is exposed, as in the first embodiment, and white LEDs 2106a to 2106d are disposed on the LED board 2106e. Here, the face of the stepped part 2110d is roughly perpendicular to the front of the cabinet and a bottom part 2110e of the recess. The outer periphery of the speaker cover 210 forms roughly a triangle and one longitudinal side of the triangle is longer than one lateral side, so that the LEDs 2106a to 2106d are disposed on the longitudinal side for largely spacing the four LEDs from each other, enhancing the LED light diffusion effect. It is also considered that the LED board 2106e is attached to the oblique line of the triangle; however, the LED board 2106e is attached to the longitudinal side from the viewpoint of difficulty of working and attaching. To set the distance until the LED light arrives at the front of the speaker cover 210 larger than that in the related art and to prevent the player from recognizing point light emission, the LEDs 2106a to 2106d are arranged so that they are not oriented for the front of the speaker cover 210, namely, the LED light does not directly arrive at the front of the speaker cover 210. Here, the direction of the light ray from the LEDs 2106a to 2106d is not a single direction and has an angle of several ten degrees; in the embodiment, the perpendicular direction to the LED board 2106e is the orientation of the LEDs 2106a to 2106d. Attachment holes 2101a to 2105a for fitting attachment projections 2101 to 2105 are made in the outer periphery of the recess. Further, the surface of a part of the cabinet containing the recess is formed with a mirror surface by a process such as metal plating for reflecting the light from the LEDs 2106a to 2106d on the recess for complementing the light amount from the speaker cover 210. Here, the recess is formed on the bottom 2110e with asperities (provided by forming continuous quadrangular pyramid shapes).

According to the configuration, the light of the LEDs 2106a to 2106d is diffused as the light is irregularly reflected by the asperities 2107 (shown in FIG. 6) formed on the outer periphery of the inner surface of the speaker cover 210, the front and the surroundings of the speaker, and the asperities (shown in FIG. 16) formed on the bottom 2110e of the recess on the cabinet front and passes through the speaker cover 210, so that the player is given the impression as if the full face of the speaker cover 210 emitted light. Particularly, the asperities are also formed on the bottom 2110e of the recess on the cabinet front, so that the effect of diffusing the LED light is furthermore enhanced.

In the description of the third embodiment, quadrangular pyramid shapes are continuously formed on the bottom 2110e of the recess on the cabinet front. In the invention, if circular cones, triangular pyramids, hemispheres, a stepped shape, or the like is used, similar advantages can also be provided. Further, if different shapes are mixed or an irregular shape is used, similar advantages can also be provided.

In the description of the third embodiment, the speaker cover 210 is formed on the inner surface (back) with the asperities 2107. In the invention, if the speaker cover 210 is formed on the inner surface with continuous steps (containing stepped shape), similar advantages can also be provided. Alternatively, if a diffusion sheet (containing a prism sheet) is provided in the speaker cover 210, similar advantages can also be provided.

In the description of the third embodiment, the speaker cover 210 is formed on the inner surface (back) with the asperities 2107. In addition, in the invention, the speaker cover 210 may be formed on the outside (surface) with a lens face. In this case, the effect of further diffusing light irregularly reflected on the asperities 2107 can be provided.

In the description of the third embodiment, the perpendicular direction to the LED board 2106e is the orientation of the LEDs 2106a to 2106d. In the invention, if any direction other than the perpendicular direction to the LED board 2106e is the orientation of the LEDs 2106a to 2106d, similar advantages can also be provided.

In the description of the third embodiment, the LED board 2106e is attached to a part of the stepped part 2110d of the recess 2110 in which the speaker main unit 2108 is embedded. In the invention, if the LED board 2106e is attached to the full peripheral surface of the stepped part 2110d or if the stepped part 2110d is formed with a belt-like groove deeper than the thickness of the LED board 2106e and the LED 2106a to 2160d and wider than the width of the LED board 2106e is formed and the LED board 2106e is attached to the groove, similar advantages can also be provided.

If the first to third embodiments are used in combination, similar advantages can also be provided. Further, in the description of the first to third embodiments, the invention is applied to the pinball slot machines. However, if the invention is applied to any gaming machine such as a pinball machine other than slot machines, similar advantages can also be provided.

As described above, according to the invention, the placement of the light source of the light emission means (containing the LEDs) is changed from the front to the side relative to the front of the gaming machine and the light from the light source gets indirectly to the player, so that the player can be given the impression that the full face of the cover (containing the speaker cover) emits light.

According to the invention, the light source of the light emission means is disposed in the stepped part 2110d of the recess in the cabinet of the gaming machine, so that giving the player the impression that the light source of the light emission means placed sideways in the stepped part emits light at a point can be avoided.

According to the invention, the asperity shape formed on the inner surface of the cover irregularly reflects and diffuses light emitted by the light emission means, so that the player can be given the impression that the full face of the cover emits light.

According to the invention, the LEDs are used as the light emission means, so that giving the player the impression that light is emitted at a point can be avoided from the orientation and the size of the light source.

Although only some exemplary embodiments of the invention have been described in detail above, those skilled in the art will readily appreciate that many modifications are possible in the exemplary embodiments without materially departing from the novel teachings and advantages of the invention. Accordingly, all such modifications are intended to be included within the scope of the invention.

This application is related to co-pending U.S. patent applications entitled “GAMING MACHINE” referred to as Attorney Docket No. SHO-0019, “GAMING MACHINE” referred to as Attorney Docket No. SHO-0020, “GAMING MACHINE” referred to as Attorney Docket No. SHO-0021, “GAMING MACHINE” referred to as Attorney Docket No. SHO-0022, “GAMING MACHINE” referred to as Attorney Docket No. SHO-0023, “GAMING MACHINE” referred to as Attorney Docket No. SHO-0024, “GAMING MACHINE” referred to as Attorney Docket No. SHO-0025, “GAMING MACHINE” referred to as Attorney Docket No. SHO-0026, “GAMING MACHINE” referred to as Attorney Docket No. SHO-0027, “GAMING MACHINE” referred to as Attorney Docket No. SHO-0028, “GAMING MACHINE” referred to as Attorney Docket No. SHO-0029, “GAMING MACHINE” referred to as Attorney Docket No. SHO-0030, “GAMING MACHINE” referred to as Attorney Docket No. SHO-0031, “GAMING MACHINE” referred to as Attorney Docket No. SHO-0032, “GAMING MACHINE” referred to as Attorney Docket No. SHO-0033, “GAMING MACHINE” referred to as Attorney Docket No. SHO-0034, “GAMING MACHINE” referred to as Attorney Docket No. SHO-0035, “GAMING MACHINE” referred to as Attorney Docket No. SHO-0036, “GAMING MACHINE” referred to as Attorney Docket No. SHO-0037, “GAMING MACHINE” referred to as Attorney Docket No. SHO-0038, “GAMING MACHINE” referred to as Attorney Docket No. SHO-0039, “GAMING MACHINE” referred to as Attorney Docket No. SHO-0040, “GAMING MACHINE” referred to as Attorney Docket No. SHO-0041, “GAMING MACHINE” referred to as Attorney Docket No. SHO-0042, “GAMING MACHINE” referred to as Attorney Docket No. SHO-0043, “GAMING MACHINE” referred to as Attorney Docket No. SHO-0044, “GAMING MACHINE” referred to as Attorney Docket No. SHO-0045, “GAMING MACHINE” referred to as Attorney Docket No. SHO-0046, “GAMING MACHINE” referred to as Attorney Docket No. SHO-0047, “GAMING MACHINE” referred to as Attorney Docket No. SHO-0048, “GAMING MACHINE” referred to as Attorney Docket No. SHO-0049, “GAMING MACHINE” referred to as Attorney Docket No. SHO-0050, “GAMING MACHINE” referred to as Attorney Docket No. SHO-0051, “GAMING MACHINE” referred to as Attorney Docket No. SHO-0052, “MOTOR STOP CONTROL DEVICE” referred to as Attorney Docket No. SHO-0053, “GAMING MACHINE” referred to as Attorney Docket No. SHO-0054, “GAMING MACHINE” referred to as Attorney Docket No. SHO-0055, “GAMING MACHINE” referred to as Attorney Docket No. SHO-0056, and “GAMING MACHINE” referred to as Attorney Docket No. SHO-0057, respectively, all the applications being filed on Oct. 31, 2003 herewith. The co-pending applications including specifications, drawings, and claims are expressly incorporated herein by reference in their entirety.

What is claimed is:

1. A gaming machine comprising:
internal lottery means configured to hold an internal lottery of a game using a random number at a predetermined timing;
sound output means having a part exposed to a front surface of a cabinet of the gaming machine and configured to output sound toward a front direction;
light emission means disposed away from the exposed part of the sound output means and attached to the cabinet, the light emission means configured to emit light; and
a cover being provided to surround the exposed part of the sound output means and to cover the light emission means,
wherein a light source of the light emission means is oriented to be substantially in parallel with the front surface of the cabinet of the gaming machine.

2. The gaming machine as claimed in claim 1 further comprising a recess having a stepped part and formed on the front surface of the cabinet,
wherein the sound output means comprises a part exposed to a bottom of the recess, and
wherein the light emission means is attached to the stepped part of the recess.

3. The gaming machine as claimed in claim 1, wherein the cover comprises a continuous asperities being formed on an inner surface thereof.

4. The gaming machine as claimed in claim 1, wherein the light emission means comprises a light emitting diode.
